(19) United States
(12) Patent Application Publication
(10) Pub. No.: US 2009/0188729 A1
(43) Pub. Date: Jul. 30, 2009

(54) Track sphere wheel assembly

(76) Inventors: Benjamin Lawrence Berry, Lake Oswego, OR (US); Benny Lee Berry, Palmdale, CA (US)

Correspondence Address: BENJAMIN LAWRENCE BERRY, 18522 ANDUIN TERRACE, LAKE OSWEGO, OR, 97034, US

(21) Appl. No.: 12/011,045

(22) Filed: Jan. 24, 2008

(51) Int. Cl. B62D 57/00

(52) U.S. Cl. 180/7.1

(57) ABSTRACT

The Track Sphere Wheel Assembly is a new and useful automotive product. This invention offers a spherical wheel and tire combination for the 21^{st} Century. The invention will accommodate electric motors at each Track Sphere wheel location for propulsion which eliminates the requirement for heavy steel drivetrains.

### BACKGROUND OF THE INVENTION

This invention relates to a new and useful Track Sphere Wheel Assembly for use in the Transportation Industry. Currently, the separate wheels and tires that are in use for automobiles and trucks require heavy steel drivetrains. The tires are also subject to punctures which cause flat tires.

The Track Sphere Wheel Assembly opens up new possibilities for drivetrains. This is a wheel and tire combination in a single unit, which is capable of moving in any direction. This invention is invented for the Green Environment where the drivetrain consists of the use of electric motors for the principal propulsion sources.

The time has come for a paradigm shift to a new wheel and tire concept in the automotive industry that will open up possibilities of new Drivetrains that can accommodate individual electric motors applied directly to each wheel position.

### BRIEF SUMMARY OF THE INVENTION

It is an object of this invention to provide a new and useful wheel and tire combination which will offer a new dimension in automobile drivetrains.

It is another object of the invention to provide a tire that will not go flat when punctured.

Yet another object of the invention is to provide a new Track Sphere Wheel Assembly for the 21^{st} Century Automotive Industry.

According to one aspect of this invention, it provides advancement to the Automotive Industry.

### BRIEF DESCRIPTION OF THE DRAWING

FIG. 1 shows a method of fabricating the Track Sphere Wheel with a view of the finished product.

FIG. 2 depicts the Track Sphere Wheel installed in the chassis assembly that accommodates its motion in all directions.

### DETAILED DESCRIPTION OF THE INVENTION

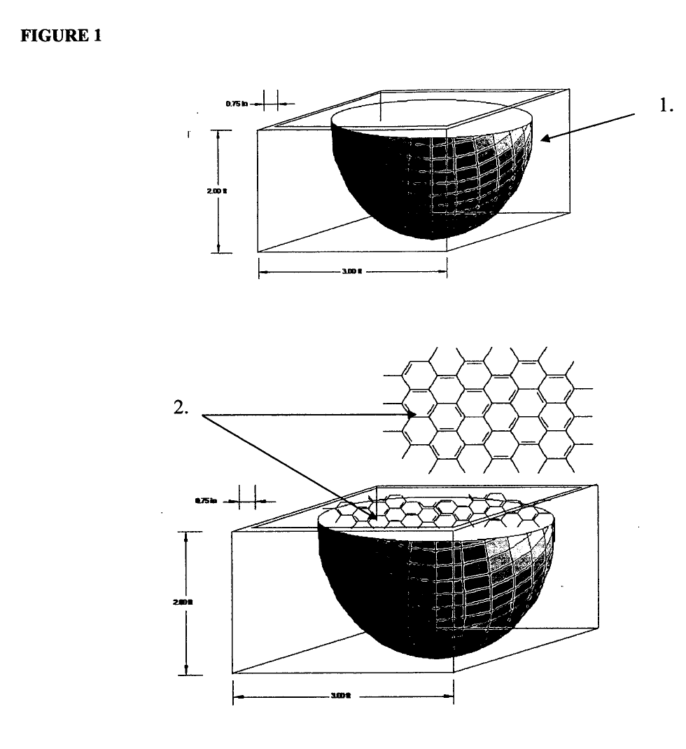

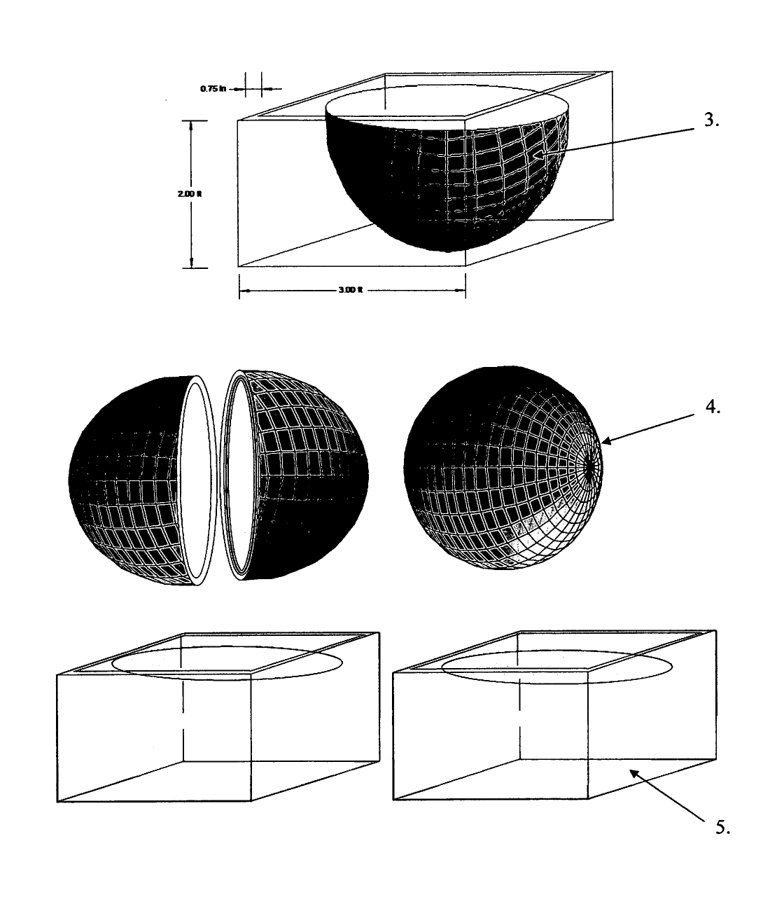

Referring initially to FIG. 1 of the drawing, the Half Sphere Mold 1 is formed out of concrete or machined out of steel. A 3 Ft.×3 Ft. piece of steel Honeycomb Material 2 is placed on top of the of mold cavity. It is formed into the shape of a hemisphere by a hydraulic press machine or hammered to conform to the mold cavity.

This process produces a steel honeycomb hemisphere 3. The interior of two hemispheres 3 are coated with resin and covered with a coarse fiberglass cloth followed by a layer of thin fiberglass cloth, to achieve a smooth interior of each hemisphere. These two hemispheres are stick-welded together to form a sphere 4.

A concrete Track Sphere Tread Mold 5 is constructed with the tread design cut into the cavity. The interior of the Tread Mold cavity is coated with soft tire tread rubber to a depth of one-half inch. The tire tread soft rubber is covered with steel wire mesh. The Hemisphere 4 is then placed into the Track Sphere Tread Mold 5 on top of the Tire Tread rubber. The half covered sphere 6 is placed into the Tread Mold 5 to cover the uncovered half of the steel honey comb sphere 4. The final product is the Track Sphere Wheel 7 which is cured in an autoclave.

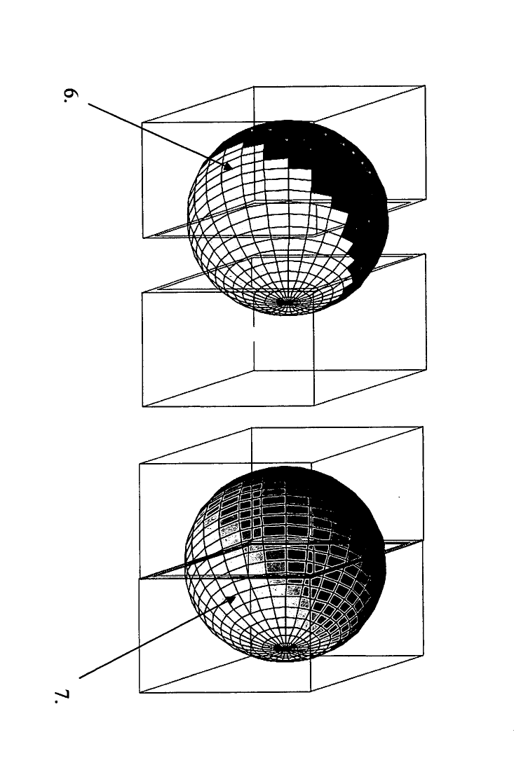

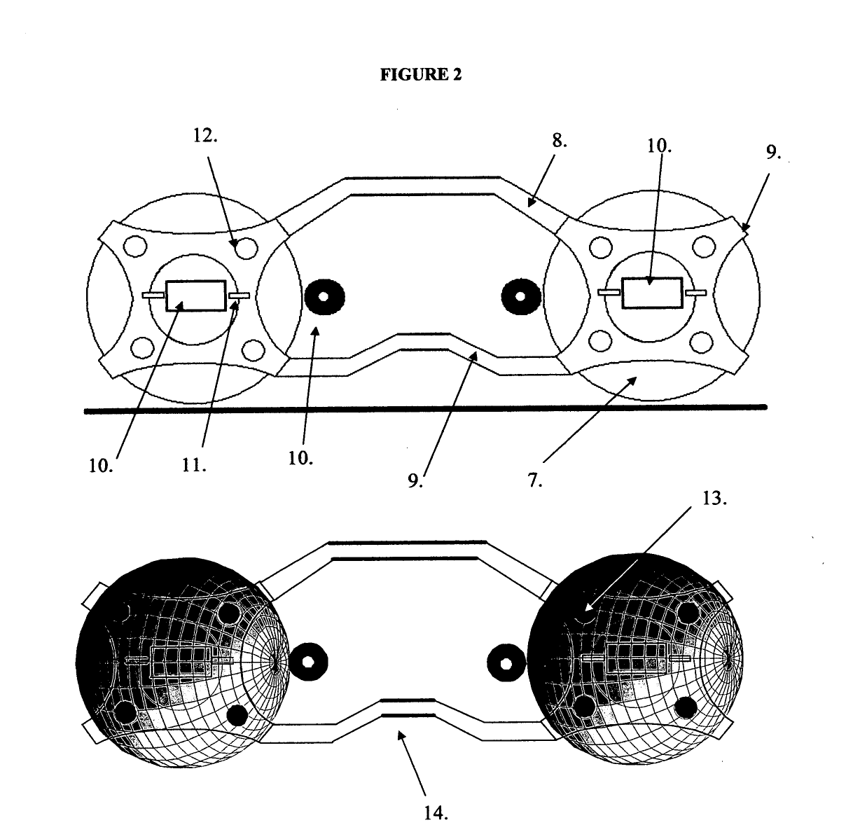

Referring to FIG. 2, the drawing depicts the Track Sphere Wheel 7 installed in the Chassis Assembly 8, which allows its motion in any direction. The Chassis Assembly 8 has twenty-four Ball bearing Rings 12 with associated twenty-four Ball bearings 13 which hold the Track Sphere 7 securely in place when the Chassis 9 is bolted together. Typically for each Track Sphere, three electric Motors 10 are attached to the Chassis 9 by a Dual Spring 11 which maintains positive spring pressure to the Track Sphere when the Motor 10 is engaged with the Track Sphere 7. This completes the Track Sphere Wheel Assembly 14.

While this invention is herein described by way of some embodiments, it should be understood that the invention is not limited to the particular embodiments and other combinations are possible without departing from the scope and principles of this invention as defined in the appended claims.

We claim:

1. A means of moving a transportation vehicle in any 360-degree direction along a roadway.

2. A means to directly move left or right from vehicle center for lateral parking of a vehicle.

3. A means to replace heavy drivetrains with light weight computer controlled drive-by-wire Track Spheres that use electric motors and cables to maneuver a vehicle.

4. An automotive wheel and tire combination for replacement of separate vehicle wheels and tires.

5. A ground transit Track Sphere Assembly that does not go flat when punctured.

6. A chassis assembly which holds the Track Sphere in place and allows motion in all directions of claim #1.
